(19) United States
(12) Patent Application Publication
(10) Pub. No.: US 2008/0154621 A1
(43) Pub. Date: Jun. 26, 2008

(54) Method for verifying defective material list

(76) Inventor: Ping-Chen Wu, Taipei (TW)

Correspondence Address: HARNESS, DICKEY & PIERCE, P.L.C., P.O. BOX 8910, RESTON, VA, 20195, US

(21) Appl. No.: 11/642,836

(22) Filed: Dec. 21, 2006

(51) Int. Cl. G06Q 10/00

(52) U.S. Cl. 705/1

(57) ABSTRACT

A method for verifying defective material list is provided. The final verification of the defective material list is done by determining the responsibility attribution in the last verified defective material list. The material processing situation and the responsibility attribution are thus obtained for future references of material purchases. This can reduce the purchase risk and increase the working efficiency of the enterprise.

### BACKGROUND OF THE INVENTION

1. Field of Invention

The present invention relates to a method for verifying a defective material list. In particular, the final verification of the defective material list is done by determining the responsibility attribution in the last verified defective material list. The material processing situation and the responsibility attribution are thus obtained for future references of material purchases.

2. Related Art

Purchase management is a management for material order, inspection, delivery, and so on. A good purchase management may help an enterprise to achieve the goal of receiving purchased material in time with a lowest purchase price.

FIG. 1 shows a flow chart of the conventional verification process of a defective material. After the material department 100 submits a material order list, the purchase department 110 sends out the material order list to material suppliers. After receiving the ordered materials, the purchase department 110 will notify the material department 100 for inspection. The material department 100 then identifies the materials whether each of the materials is corrected and qualified according to the material order list. If any item is unconformity with the material order list, a defective material list is then issued.

The defective material list is sent to the purchase department 110 or other departments for further verification (e.g. a first department 120, a last department 130) for verifying via a network. In particular, the purchase department 110 or the other departments may assign a department in next for verifying the defective material. When the defective material list has been verified and signed, it returns to the purchase department 110. Then the purchase department 110 communicates with the material suppliers to identify the responsibility attribution of the defective material and make a final result. Afterwards, the purchase department 110 may re-sign the defective material list with some opinions and then save the defective material list.

However, in the conventional verification procedure, the final result for the defective material in the defective material list may not be as same as the one verified by the verified department. Also, the final result may not feed back to the verified department. Therefore, the verified department is unable to know the final result of the defective material and who is responsible for the defective material. Therefore, it is a flaw in the conventional verification procedure for the defective material list.

### SUMMARY OF THE INVENTION

It is an object of the present invention to provide a method for verifying a defective material list. The final verification of the defective material list is done by determining the responsibility attribution of the last verified defective material list, and the material processing situation and the responsibility attribution are thus obtained for future references of material purchases. Therefore, the present invention may reduce the purchase risk and increase the working efficiency of the enterprise.

It is another object of the present invention to provide a method for verifying a defective material list. The defective material list disclosed herein is applied to a material list verification system. The defective material list containing a responsibility attribution is transmitted to at least one department according to a verification procedure. Once each department follows and completes the verification procedure, the verification of defective material list is implemented.

The present invention is characterized in that: according to the responsibility attribution in the last verified material defective list to determine which department should receive the re-issued last verified defective material list.

It is an advantage of the present invention that the disclosed method for verifying a defective material list can solve the problems in the conventional purchase verification procedure. It is also possible to obtain the last material processing situation and the corresponding responsibility attribution for the references of future purchases. This can reduce the purchase risk and increase the working efficiency of the enterprise.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a flowchart of the conventional verification process of a defective material list;

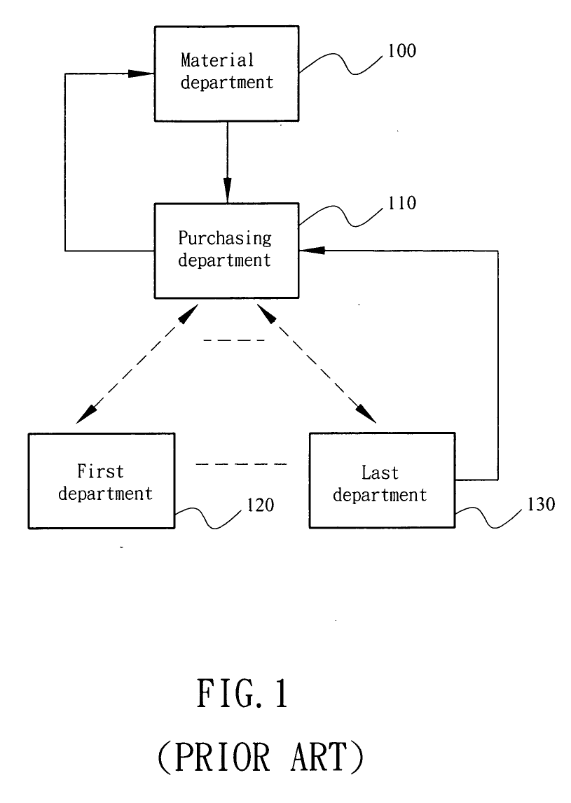

FIG. 2 is a flow chart of the method for verifying a defective material list;

FIGS. 3A and 3B are the defective material list verified and signed by the material department according to one embodiment of the present invention;

FIGS. 4A and 4B are the defective material list verified and signed by the purchase department according to one embodiment of the present invention;

FIGS. 5A and 5B are the defective material list verified and signed by the R&D department according to one embodiment of the present invention; and

FIGS. 6A and 6B are the defective material list verified and signed by the material department according to one embodiment of present invention.

### DETAILED DESCRIPTION OF THE INVENTION

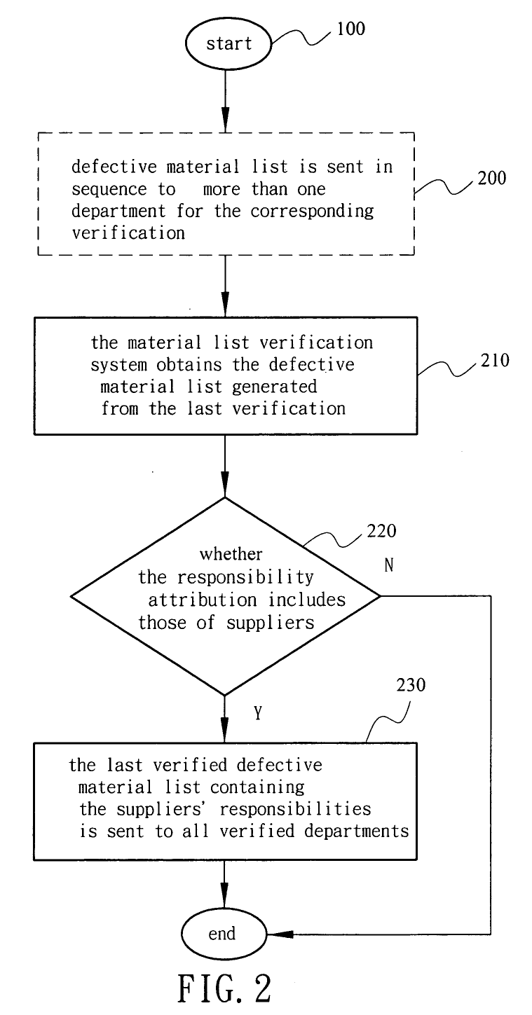

The flowchart of the disclosed method for verifying a defective material list shown in FIG. 2 is used in a material list verification system. The defective material list containing a responsibility attribution is sent in sequence to more than one department for the corresponding verification according to the predetermined verification procedure (step 200). After each department completes its verification procedure for the defective material, the material list verification system obtains the defective material list generated from the last verification (step 210).

Afterwards, the material list verification system confirms whether the responsibility attribution in the last verified defective material list includes those of suppliers (step 220). If the material list verification system confirms the responsibility attribution in the last verified defective material list including those of suppliers, then the last verified defective material list containing the suppliers' responsibilities is sent to all verified departments (step 230).

In particular, the items in the defective material list includes a material supplier, material items, the inspection status (e.g., accept/reject the material), and the responsibility attribution (e.g., supplier's responsibility or non-supplier's responsibility).

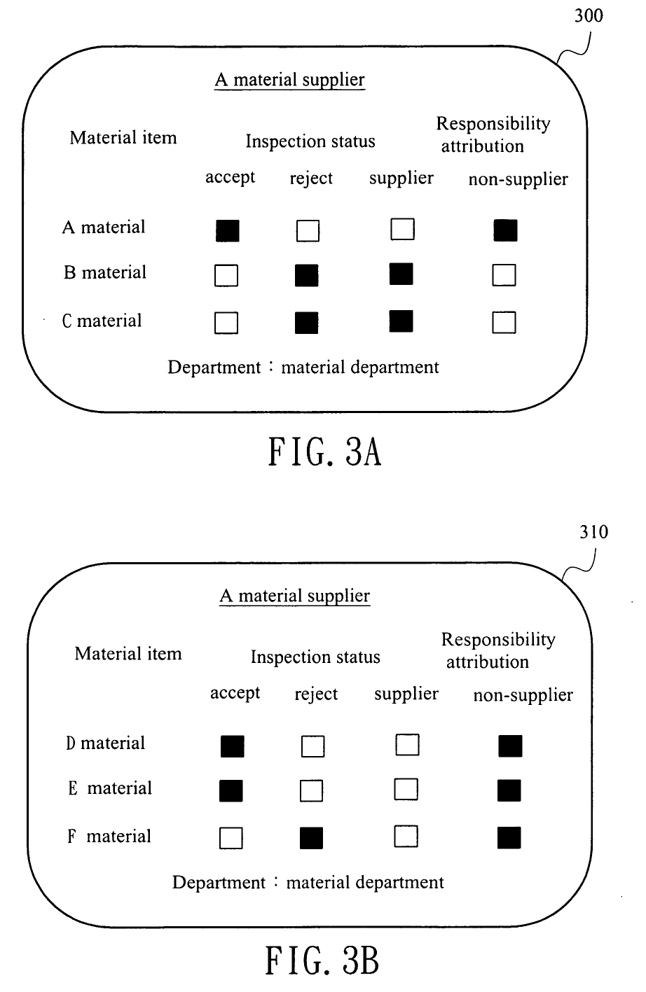

An embodiment is disclosed herein to explain the method provided by the invention. In this embodiment, the material department inspects the incoming materials provided by two material suppliers and issues the corresponding defective material lists. The two material suppliers are material supplier A and material supplier B for example, providing materials A, B, C, D, E, and F. The defective material list 300 for the material supplier A is given in FIG. 3A, whereas the defective material list 310 for the material supplier B is given in FIG. 3B.

In FIG. 3A, the inspection status in the material defective list after inspection for materials A, B, and C are respectively accept, reject, and reject. The responsibility attributions for the incoming materials are non-supplier's responsibility, supplier's responsibility, and supplier's responsibility. On the other hand, in FIG. 3B, the inspection status in the material defective list after inspection for materials D, E, and F are respectively accept, accept, and reject. The responsibility attributions for the incoming materials are all non-supplier's responsibilities. Afterwards, the two defective material lists 300, 310 are signed via the network. The departments may include the purchase department and the research and development (R&D) department for verifying and cosigning.

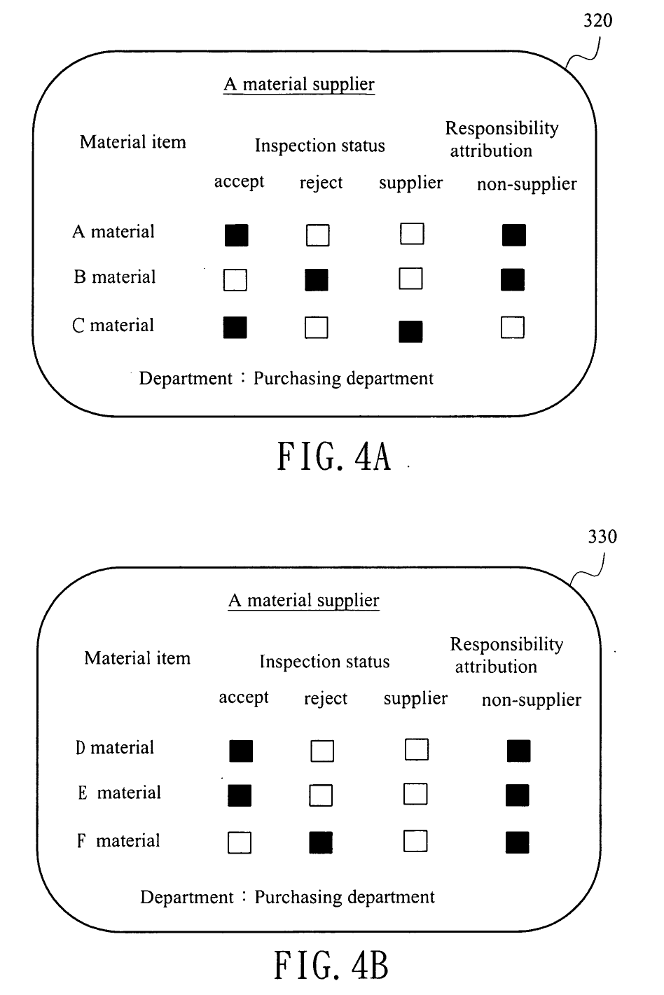

First, the defective material lists 300, 310 in FIGS. 3A and 3B are transmitted in sequence to the purchase department for verification. The purchase department follows the items of inspection status, responsibility attribution, and their understanding of the material to verify the defective material lists 300, 310 and add their opinions. In this embodiment, the responsibility attribution of material B provided by the material supplier A is changed from the supplier's responsibility to non-supplier's responsibility. The inspection status of material C is changed from reject to accept. New defective material lists 320, 330 in FIGS. 4A and 4B, respectively, are then generated.

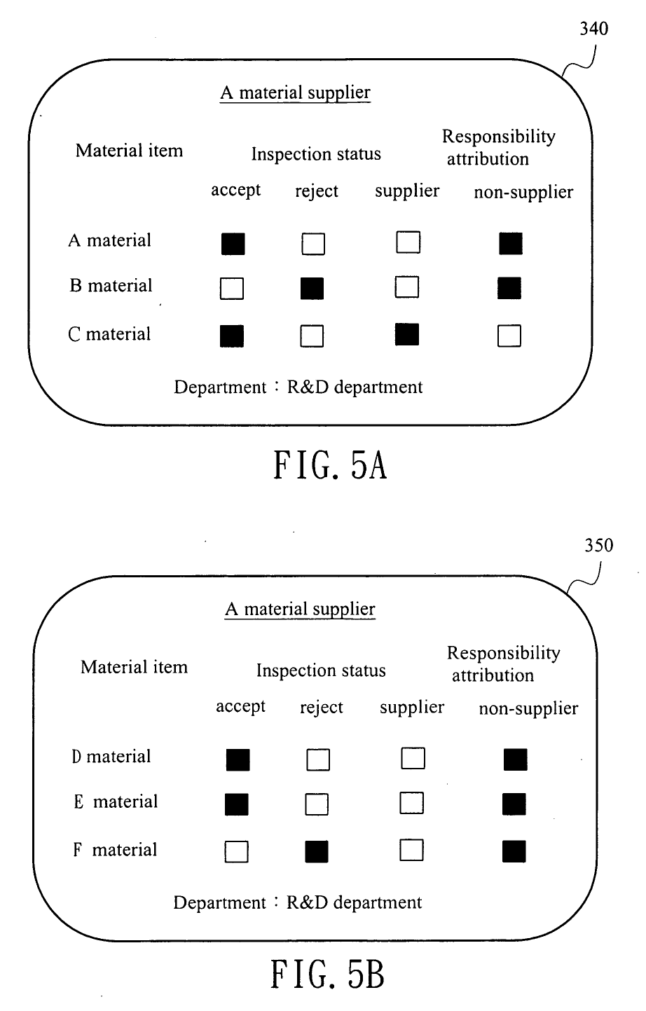

Afterwards, the defective material lists 320, 330 in FIGS. 4A and 4B are transmitted via the network according to the predetermined verification procedure to the material department to verify the inspection status and the responsibility attribution for the incoming material. The material department further adds their opinions and generates new defective material lists 340, 350 as shown in FIGS. 5A and 5B. And then, the defective material lists 340, 350 are transmitted to the R&D department for verifying and cosigning. In the embodiment, the verification result of the R&D department is the same as that of the purchase department.

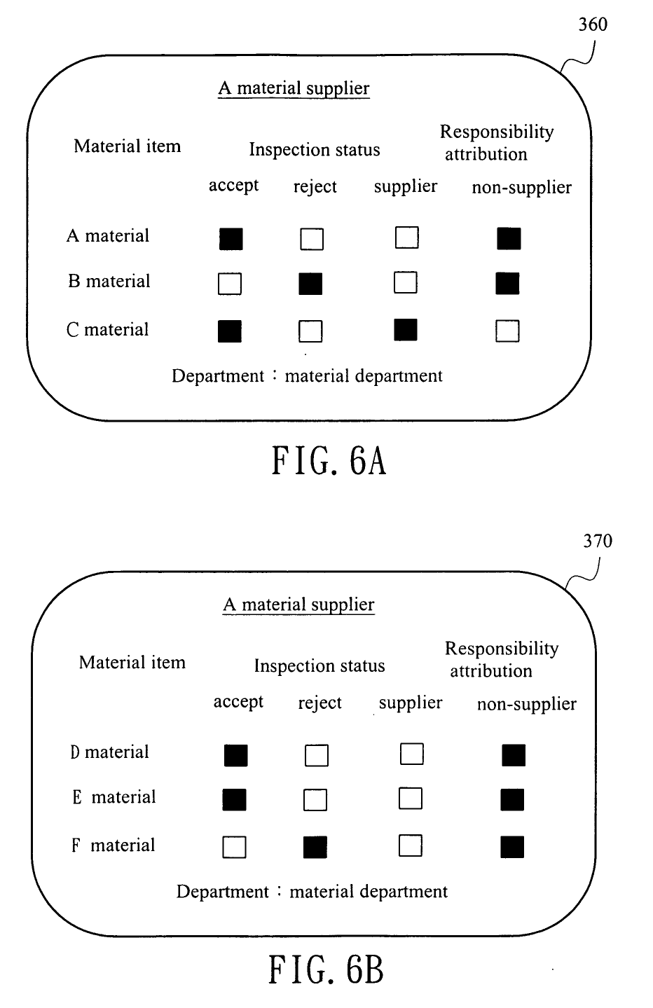

When the defective material lists 340, 350 in FIGS. 5A and 5B are returned according to the predetermined verification procedure to the material department, the material department further verifies the inspection status and the responsibility attribution according to the defective material lists 340, 350. If the material department agrees with the verification result of the material defective lists 340, 350 in FIGS. 5A and 5B, the defective material lists 360, 370 shown in FIGS. 6A and 6B are generated. They are the last verified defective material lists.

Afterwards, the material list verification system starts to determine whether the responsibility attributions in the defective material lists 360, 370 in FIGS. 6A and 6B include the supplier's responsibilities. Since the responsibility attribution of material C in the defective material list 350 of FIG. 6A is considered as the supplier's responsibility, the material list verification system re-issues the defective material list of FIG. 5A to the purchase department and the R&D department for them to know of the last verification of the incoming material.

It is known from the above description that the disclosed method for verifying a defective material list can solve the problems in the conventional purchase verification procedure. It is also possible to obtain the last material processing situation and the corresponding responsibility attribution for the references of future purchases. This can reduce the purchase risk and increase the working efficiency of the enterprise.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for verifying a defective material list used in a material list verification system to transmit at least one defective material list containing an item of responsibility attribution in sequence to more than one departments for verification and, a final verification procedure to the defective material list is performed after completing the verification procedure of the defective material list, wherein the method is characterized in that: according to the responsibility attribution in the last verified material defective list to determine which department should receive the re-issued last verified defective material list.

2. The method for verifying a defective material list of claim 1, wherein the defective material list contains items of a material supplier, at least one material item, an inspection status, and a responsibility attribution.

3. The method for verifying a defective material list of claim 2, wherein the inspection status comprises selection items of accepting and rejecting.

4. The method for verifying a defective material list of claim 2, wherein the responsibility attribution includes selection items of a supplier's responsibility and a non-material supplier's responsibility.

5. The method for verifying a defective material list of claim 4, wherein the last verified defective material list is re-sent to all verified departments when the supplier's responsibility is selected in the last verified defective material list.
